(19) United States
(12) Patent Application Publication
(10) Pub. No.: US 2026/0064607 A1
(43) Pub. Date: Mar. 5, 2026

(54) ELECTRONIC DEVICE INCLUDING PLURALITY OF PROCESSORS AND OPERATING METHOD OF ELECTRONIC DEVICE

(71) Applicant: SAMSUNG ELECTRONICS CO., LTD., Suwon-si (KR)

(72) Inventors: Yongmin JUNG, Suwon-si (KR); Yunnyung KIM, Suwon-si (KR)

(73) Assignee: SAMSUNG ELECTRONICS CO., LTD., Suwon-si (KR)

(21) Appl. No.: 19/313,107

(22) Filed: Aug. 28, 2025

(30) Foreign Application Priority Data
Aug. 29, 2024 (KR) 10-2024-0117155

(51) Int. Cl. G06F 12/14; G06F 11/30

(52) U.S. Cl. CPC G06F 12/1458; G06F 11/3034

(57) ABSTRACT

An electronic device includes a plurality of processors including a secure processor operating in a secure execution environment and a processor group including at least one processor, one or more processors including processing circuitry, and a memory storing instructions and data related to the plurality of processors. The instructions, when executed by the one or more processors individually or collectively, cause the electronic device to block a transaction, issued by an unauthorized processor from among the plurality of processors, with respect to an access prevention memory region, based on access prevention memory region information including a valid master, identification information of the access prevention memory region, and properties of the access prevention memory region.

### CROSS-REFERENCE TO RELATED APPLICATIONS

This application is based on and claims priority under 35 U.S.C. § 119 to Korean Patent Application No. 10-2024-0117155, filed on Aug. 29, 2024, in the Korean Intellectual Property Office, the disclosure of which is incorporated by reference herein in its entirety.

### BACKGROUND

### 1. Field

The present disclosure relates to an electronic device including a plurality of processors and an operating method of the electronic device, and more particularly, to protecting a memory region of electronic device including a plurality of processors.

### 2. Description of Related Art

Recently, an Internet of Things (IoT) device may need to implement a security function as a core function. For example, an ultra-wideband (UWB)-based IoT device may be used in a door lock application. Such a system may need to process confidential and/or secured data. As the application becomes more complex, the system requires additional processing elements (e.g., multiple processors) and/or a direct memory access (DMA) for accessing code and/or data in a static random access memory (SRAM). Accordingly, a possibility of injecting malicious code into a processor increases and as a result, sophisticated detection thereof is required.

### SUMMARY

One or more example embodiments of the present disclosure provide for protecting a memory region of a device including a plurality of processors.

According to an aspect of the disclosure, an electronic device includes a plurality of processors including a secure processor operating in a secure execution environment and a processor group including at least one processor, one or more processors including processing circuitry, and a memory storing instructions and data related to the plurality of processors. The instructions, when executed by the one or more processors individually or collectively, cause the electronic device to block a transaction, issued by an unauthorized processor from among the plurality of processors, with respect to an access prevention memory region, based on access prevention memory region information including a valid master, identification information of the access prevention memory region, and properties of the access prevention memory region.

According to an aspect of the disclosure, an electronic device includes a plurality of processors including a secure processor operating in a secure execution environment and a processor group including at least one processor, one or more processors including processing circuitry, a memory storing instructions and data related to the plurality of processors, a centralized address protection table (CAPT) storing access prevention memory region information including a valid master, an access prevention memory region, and properties of the access prevention memory region, and at least one direct memory access (DMA) including a channel configured by at least one of the plurality of processors. The instructions, when executed by the one or more processors individually or collectively, cause the electronic device to block, based on the CAPT, a transaction, issued by an unauthorized processor from among the plurality of processors, with respect to the access prevention memory region, and monitor a stack region of the memory for the plurality of processors.

According to an aspect of the disclosure, an operating method of an electronic device includes monitoring transactions of a plurality of processors including a secure processor operating in a secure execution environment and a processor group including at least one processor, monitoring transactions of at least one channel of a direct memory access (DMA), blocking, based on access prevention memory region information, a transaction, issued by an unauthorized processor from among the plurality of processors, with respect to an access prevention memory region, the access prevention memory region information including a valid master, identification information of the access prevention memory region, and properties of the access prevention memory region, and blocking the transactions of the at least one channel based on DMA configuration information and the access prevention memory region information. The DMA configuration information includes an identification (ID) of a processor configuring the DMA, a source address region of the at least one channel, and a destination address region of the at least one channel.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a block diagram of a wireless communication device, according to an embodiment;

FIG. 2 illustrates a block diagram of a wireless communication device including a direct memory access (DMA), according to an embodiment;

FIG. 3 illustrates a data structure of a memory of a wireless communication device, according to an embodiment;

FIG. 4 illustrates a security architecture in which a security check and monitoring system are implemented, according to an embodiment;

FIG. 5 illustrates a data structure of a static random access memory (SRAM) of a wireless communication device including a plurality of processors, according to an embodiment;

FIG. 6 illustrates memory region allocation, according to an embodiment;

FIG. 7 illustrates an example of a centralized address protection table (CAPT), according to an embodiment;

FIG. 8 illustrates a configuration check table (CCT), according to an embodiment;

FIG. 9 illustrates an operation of a wireless communication device in the event of a change in an access prevention memory region of a memory used by a processor, according to an embodiment;

FIG. 10 illustrates an operating method of a wireless communication device including a plurality of processors, according to an embodiment;

FIG. 11 illustrates an operating method of a wireless communication device including a plurality of processors, according to an embodiment;

FIGS. 12A, 12B, and 12C illustrate an operating method of a wireless communication device including a plurality of processors, according to an embodiment;

FIG. 13 illustrates an operating method of a wireless communication device including a plurality of processors, according to an embodiment;

FIG. 14 is a diagram illustrating a system to which a processor group and a DMA are applied, according to an embodiment; and

FIG. 15 is a conceptual diagram illustrating an Internet of Things (IoT) network system to which one or more embodiments are applied.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to”another element or layer, there are no intervening elements or layers present.

The terms “upper,” “middle”, “lower”, or the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, or the like may be used to distinguish components from each other and do not limit the present disclosure. For example, the terms “first”, “second”, “third”, or the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, example embodiments of the present disclosure are described in detail with reference to the accompanying drawings.

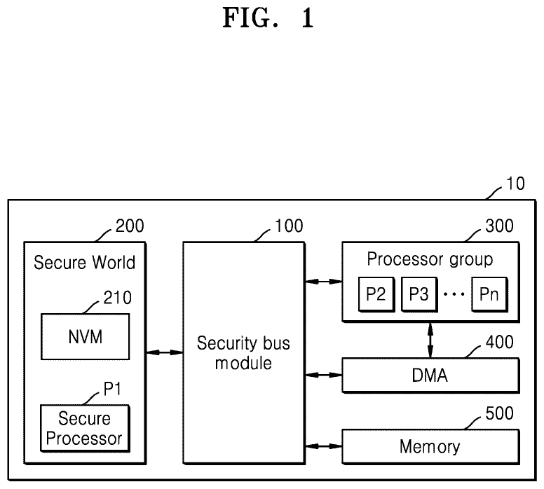

FIG. 1 illustrates a block diagram of a wireless communication device, according to an embodiment.

Referring to FIG. 1, a wireless communication device 10 may include a security bus module 100, a secure world 200, a processor group 300 including at least one processor, a direct memory access (DMA) 400, and a memory 500. According to an embodiment, the wireless communication device 10 may be and/or may include an Internet of Things (IoT) device and may include at least a plurality of processors (e.g., a secure processor P1, a second processor P2, a third processor P3, to n-th processor Pn, where n is a positive integer greater than one (1)). That is, the wireless communication device 10 may be and/or may include an IoT device as an entity communicating with other wireless communication devices. The IoT device may include, but not be limited to, at least one of light bulbs, various sensors, sprinkler devices, fire alarms, thermostats, streetlights, toasters, exercise machines, hot water tanks, heaters, boilers or the like.

An IoT network and the IoT device may be designed to provide a distributed computing configuration from various end points. The IoT device may be and/or may include a physical or virtual object that may communicate in the IoT network, and may include, but not be limited to, a sensor, an actuator, and other input/output components that may be used to collect data and/or perform an operation in a real environment. For example, the IoT device may be and/or may include a low-power endpoint device that may be embedded in and/or attached to an everyday object such as, but not be limited to, a building, a vehicle, and/or a package to provide an additional level of artificial sensory perception of the object.

In an embodiment, the security bus module 100 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the security bus module 100. As another example, a processor in combination with a memory may be used to execute one or more instructions to perform the functionality of the security bus module 100. Alternatively or additionally, at least a portion of the functionality of security bus module 100 may be incorporated into the secure processor P1 and/or implemented as instructions to be executed by the secure processor P1.

The secure world 200 may include a non-volatile memory (NVM) 210 and the secure processor P1. The secure world 200 may refer to an execution environment and/or mode. For example, the secure world 200 may refer to an environment in which a security operating system (OS) may be executed. The secure world 200 may refer to an execution environment that may be protected from hacking (e.g., unauthorized access) by having a higher security level than a non-secure world. The non-secure world may refer to an execution environment in which general OS kernels and applications may operate. The secure processor P1 may operate in the secure world 200. In an embodiment, the processor group 300 (e.g., the second to n-th processors P2 to Pn) may operate in the non-secure world.

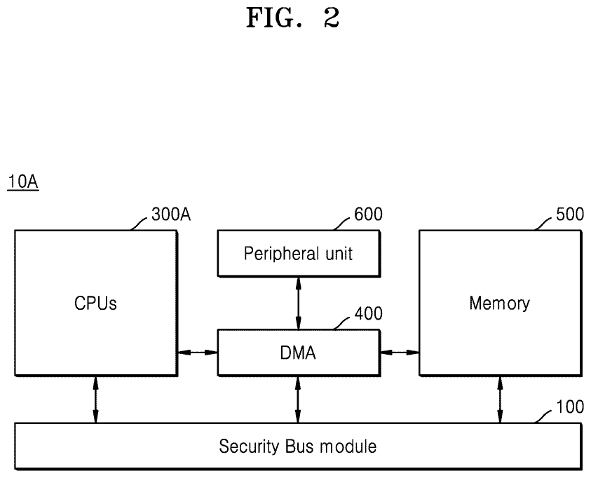

The DMA 400 may perform data transmission (e.g., memory reads, memory writes, or the like) while allowing the processors 300 to perform other operations. As used herein, the processors 300 may refer to the second to n-th processors P2 to Pn of the processor group 300. Accordingly, the processors 300 may not participate in data transmission and thus the overall operation speed of the wireless communication device 10 may increase, when compared to related wireless communication devices. While data is transmitted by the DMA 400, the processors 300 may perform other operations, thus increasing efficiency of the wireless communication device 10, when compared to related wireless communication devices. The DMA 400 is described with reference to FIG. 2.

The memory 500 may include a volatile memory such as, but not limited to, a static random access memory (SRAM) and/or a dynamic random access memory (DRAM) and/or may include a non-volatile memory (NVM) such as, but not limited to, a flash memory, a phase-change random access memory (PRAM), a resistive random access memory (RRAM), or the like. The memory 500 may also be implemented in the same package as a main processor (e.g., the secure processor P1, the processors 300.

According to an embodiment, the wireless communication device 10 may be and/or may include an entity communicating with a base station (e.g., a high power cellular base station, a low power high power cellular base station, a evolved Node B (eNB), a gNodeB (gNB)) or another wireless communication device (e.g., a radio base station, a transmit reception point (TRP)) and may be referred to as a node, a user equipment (UE), a next-generation UE (NG UE), a mobile station (MS), a mobile equipment (ME), a device, or a terminal.

According to an embodiment, the wireless communication device 10 may be and/or may include at least one of a smart phone, a tablet personal computer (PC), a mobile phone, a video phone, an electronic book reader, a desktop PC, a laptop PC, a netbook computer, a personal digital assistant (PDA), a portable multimedia player (PMP), an Moving Picture Experts Group (MPEG) Audio Layer 3 (MP3) player, a medical device, a camera, or a wearable device. Also, the wireless communication device 10 may be and/or may include, but not be limited to, at least one of a television (TV), a digital video disk (DVD) player, an audio device, a refrigerator, an air conditioner, a cleaner, an oven, a microwave oven, a washing machine, an air cleaner, a set-top box, a home automation control panel, a security control panel, a media box (e.g., Samsung HomeSync™, Apple TV™, or Goggle TV™), a game console (e.g., Microsoft Xbox™ or Sony PlayStation™), an electronic dictionary, an electronic key, a camcorder, or an electronic picture frame. Also, the wireless communication device 10 may be and/or may include at least one of various medical devices (e.g., various portable medical measuring devices (such as, but not limited to, blood sugar meters, heart rate meters, blood pressure meters, or body temperature meters), magnetic resonance angiography (MRA), magnetic resonance imaging (MRI), computed tomography (CT), cameras, or ultrasound machines), navigation devices, global navigation satellite systems (GNSS), event data recorders (EDR), flight data recorders (FDR), vehicle infotainment devices, electronic equipment for ships (e.g., navigation devices for ships and gyrocompasses), avionics, security devices, head units for vehicles, industrial or home robots, drones, automated teller machines (ATM) of financial institutions, point of sales (POS) of stores, or IoT devices (e.g., light bulbs, various sensors, sprinkler devices, fire alarms, thermostats, streetlights, toasters, exercise machines, hot water tanks, heaters, boilers, or the like).

An electronic device, according to an embodiment, may include a processor group including at least one processor and a plurality of processors including a secure processor operating in a secure world. The electronic device may correspond to the wireless communication device 10. The electronic device may include a memory storing data related to the plurality of processors and a security bus module configured to block, based on access prevention memory region information including a valid master, an access prevention memory region, and properties of the access prevention memory region, a transaction issued by an unauthorized processor with respect to the access prevention memory region among the plurality of processors. The access prevention memory region may include a stack region, a protected region, and a secured region. The properties of the access prevention memory region may include stack properties, protected properties, and secured properties. The security bus module may monitor the stack region of the memory for the plurality of processors and update the stack region of the access prevention memory region information when the stack region changes.

According to an embodiment, the processor group 300 may include a first processor, and when a first access prevention memory region associated with the first processor changes, the first processor may request the secure processor P1 to update first access prevention memory region information. In response to the request, the secure processor P1 may update the first access prevention memory region information associated with the first processor. The secure processor P1 may stop an operation of the processor group 300 before the update and resume an operation of the processor group 300 after the update.

According to an embodiment, the processor group 300 may include a first processor and a second processor, and when the second processor attempts to access a first access prevention memory region of the first processor, the security bus module 100 may determine whether to block the access of the second processor based on first access prevention memory region information about the first processor. When the first access prevention memory region information includes information that the second processor is valid for the first access prevention memory region, the security bus module 100 may allow the access of the second processor. When the first access prevention memory region information does not include information that the second processor is valid for the first access prevention memory region, the security bus module 100 may block the access of the second processor.

The electronic device may further include at least one DMA 400, a channel of which may be configured by at least one of the plurality of processors P1 to Pn. According to an embodiment, the processor group 300 may include a first processor and a second processor, and the second processor may configure a first channel of the DMA 400. The security bus module 100 may store DMA configuration information including an identification (ID) of the second processor, a source address region of the first channel, and a destination address region of the first channel by monitoring a register value of the first channel of the DMA 400. When the DMA 400 attempts to access a first access prevention memory region of the first processor through the first channel, the security bus module 100 may determine whether to block the access of the DMA 400 based on first access prevention memory region information about the first processor and the DMA configuration information. When the first access prevention memory region information includes information that the DMA 400 is valid for the first access prevention memory region, the security bus module 100 may allow the access of the DMA 400. When the first access prevention memory region information does not include information that the DMA 400 is valid for the first access prevention memory region, the security bus module 100 may block the access of the DMA 400.

The wireless communication device 10, according to an embodiment, may protect a memory region from a stack overflow attack.

The wireless communication device 10, according to an embodiment, may protect confidential data and/or code from a logical attack that may exploit a stack overflow, a return-oriented programming (ROP), a jump-oriented programming (JOP), or the like.

An unauthorized transaction may be detected through a hardwired logic and may be implemented at a relatively low cost.

FIG. 2 illustrates a block diagram of a wireless communication device 10A including a DMA, according to an embodiment. The wireless communication device 10A of FIG. 2 may include and/or may be similar in many respects to the wireless communication device 10 described above with reference to FIG. 1, and may include additional features not mentioned above. Consequently, repeated descriptions of the wireless communication device 10A described above with reference to FIG. 1 may be omitted for the sake of brevity.

Referring to FIG. 2, the wireless communication device 10A may include a plurality of central processing units (CPUs) 300A, a peripheral unit 600, a DMA 400, a memory 500, and a security bus module 100. The security bus module 100, the CPUs 300A, the DMA 400, and the memory 500 of FIG. 2 may include and/or may be similar in many respects to security bus module 100, the processors 300, the DMA 400, and the memory 500, respectively, described above with reference to FIG. 1, and may include additional features not mentioned above. Consequently, repeated descriptions of these components described above with reference to FIG. 1 may be omitted for the sake of brevity.

In an embodiment, the peripheral unit 600 may include at least one of a disk drive, an external memory, a graphics card, a network card, or a sound card.

The DMA 400 may refer to a mechanism that may allow the peripheral unit 600 to communicate data with the memory 500 without the intervention of the plurality of CPUs 300A. If the wireless communication device 10 does not include a DMA 400, when data is transmitted between the peripheral unit 600 and the memory 500, at least one of the plurality of CPUs 300A may be occupied during the period of data transmission and, consequently, may not perform other operations. When the wireless communication device 10 includes at least one DMA 400, because at least one of the CPUs 300A starts data transmission and then hands over actual data transmission to the DMA 400, the at least one of the CPUs 300A may concentrate on other operations. When the data transmission is completed, the CPUs 300A may receive an interrupt from the DMA 400 to finish the data transmission. However, the present disclosure is not limited in this regard, and the DMA 400 may signal the completion of the data transmission in other various manners.

A channel of the DMA 400 may transmit data between the connected peripheral unit 600 and the memory 500. The CPUs 300A, the memory 500, a connected input/output (I/O) device, and the DMA 400 may be connected through the security bus module 100. The DMA 400 may include a DMA controller, and the DMA controller may start a memory read/write cycle and/or may generate a memory address.

The DMA 400 may operate based on any one of a burst mode, a cycle stealing mode, and/or a transparent mode.

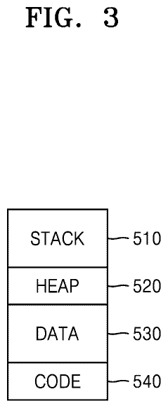

FIG. 3 illustrates a data structure of a memory of a wireless communication device, according to an embodiment. FIG. 3 may be described with reference to FIG. 1.

The memory 500 may include various memory spaces for executing a program. Referring to FIG. 3, the memory 500 may include a stack region 510, a heap region 520, a data region 530, and a code region 540. However, the present disclosure is not limited in this regard, and the memory 500 may include less regions, more regions, and/or different regions than those illustrated in FIG. 3. The stack region 510 may refer to a region in which local variables and parameters related to a function call may be stored. The stack region 510 may be allocated along with a function call and may disappear (e.g., deallocated) when the function call is completed. The wireless communication device 10 may store data in the stack region 510 by using a PUSH operation and may output (fetch) the data by using a POP operation. The stack region 510 may be based on last-in first-out (LIFO). In such an embodiment, the last data inputted (written) to the stack region 510 may be the first to be outputted. However, the present disclosure is not limited in this regard, and the stack region 510 may be structured based on other structures (e.g., first in, first out (FIFO)) without departing from the scope of the present disclosure. The function call information stored in the stack region 510 may be referred to as a stack frame. The stack region 510 may change in the dynamically allocated size, and as the allocated size increases, the stack region 510 may invade the heap region 520. This case may be referred to as a stack overflow.

The heap region 520 may refer to a region that may be directly managed by the user. A memory space of the heap region 520 may be dynamically allocated and/or released by the user.

The data region 530 may refer to a region in which global variables and static variables of the program may be stored. The data region 530 may be allocated along with the start of the program. The data region 530 may disappear (e.g., be deallocated) when the program is ended.

The code region 540 may refer to a region in which code of the program may be stored. The processors 300 may use the instructions stored in the code region 540.

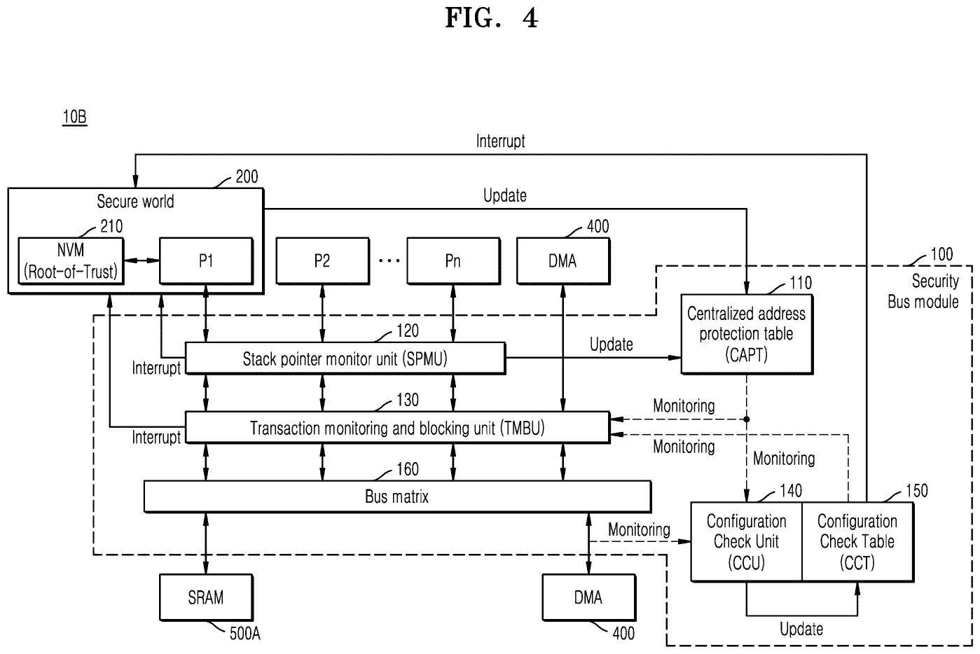

FIG. 4 illustrates a security architecture in which a security check and monitoring system are implemented, according to an embodiment.

Referring to FIG. 4, a wireless communication device 10C may include a security bus module 100, a secure world 200, a processor group (e.g., second processor P2 to n- th processor Pn), a DMA 400, and an SRAM 500A.

The wireless communication device 10B of FIG. 4 may include and/or may be similar in many respects to the wireless communication devices 10 and 10A described above with reference to FIGS. 1 to 3, and may include additional features not mentioned above. Furthermore, the security bus module 100, the processor group, the DMA 400, and the memory 500A of FIG. 4 may include and/or may be similar in many respects to security bus module 100, the processors 300, the DMA 400, and the memory 500, respectively, described above with reference to FIGS. 1 to 3, and may include additional features not mentioned above. Consequently, repeated descriptions of these components described above with reference to FIGS. 1 to 3 may be omitted for the sake of brevity.

The security bus module 100 may include a centralized address protection table (CAPT) 110, a stack pointer monitor unit (SPMU) 120, a transaction monitoring and blocking unit (TMBU) 130, a configuration check unit (CCU) 140, a configuration check table (CCT) 150, and a bus matrix 160.

The CAPT 110, the SPMU 120, the TMBU 130, the CCU 140, the CCT 150, and the bus matrix 160 may be physically implemented using electronic hardware (e.g., analog and/or digital circuits, an integrated circuit, a microprocessor, a microcontroller, a memory circuit, a passive electronic component, an active electronic component, an optical component, or the like), computer software, and/or a combination thereof.

The CAPT 110 may include information about an access prevention memory region (e.g., access prevention region). For example, the CAPT 110 may include access prevention memory region information about each of a plurality of processors. The access prevention memory region information may include whether a certain processor may access a particular memory region. That is, the access prevention memory region information may include indications as to whether an access prevention memory region is to be prevented from being accessed, properties of the access prevention memory region, a valid processor, and whether the access prevention memory region is valid. The access prevention memory region information may include information about a valid processor. The properties may include stack properties, protected properties, and secured properties. Depending on the context, the stack properties, the protected properties, and the secured properties may respectively correspond to a stack region, a protected region, and a secured region. Data in the protected region may refer to data that may be prevented from being overwritten when an application operates. Data in the secured region may refer to data that may need security to be prevented from being accessed by other processors.

In the access prevention memory region, the access to the corresponding region by other processors other than the valid processor may be blocked. That the corresponding region is valid may indicate that the corresponding region has been added as a region that may be accessed by the valid processor. That the corresponding region is invalid may indicate that the corresponding region has been removed as a region that may be accessed by the valid processor. Thus, the CAPT 110 may include valid stack region information of each processor. The access prevention memory region information may be used for transaction monitoring and blocking.

The SPMU 120 may monitor instructions fetched from the plurality of processors (e.g., secure processor P1, second processor P2, to n-th processor Pn). The SPMU 120 may estimate a valid stack region for each of the plurality of processors P1 to Pn. For example, the SPMU 120 may dynamically check a stack region of the processors plurality of P1 to Pn when at least one of the plurality of processors P1 to Pn operates as a hardware device. The SPMU 120 may be connected to each processor of the plurality of processors P1 to Pn and may operate independently. The SPMU 120 may update a valid stack region of each processor in the CAPT 110.

The CCU 140 may monitor the setting (configuration) of the plurality of processors P1 to Pn for the peripherals. For example, the CCU 140 may monitor the setting of the plurality of processors P1 to Pn for the DMA 400. The CCU 140 may update configuration information in the CCT 150. The CCT 150 may include an ID of the processor configuring the DMA 400, whether invasive or not, a source range, and a destination range. The CCU 140 may detect which peripheral device the processor has configured in a source address region and a destination address region. The CCU 140 may update the processor ID and the address region in the CCT 150. The CCU 140 may monitor the CAPT 110 to determine whether the DMA configuration may damage the protected or secured memory region registered in the CAPT 110.

A stack pointer may refer to a register that may indicate the position of the last value in the stack region. The stack pointer may be initialized to a stack base. The stack base may refer to a start address of the stack. The stack pointer may decrease when new data is stored in the stack during the runtime. In general, a PUSH operation and/or a POP operation may be used to store register contents in the stack region when a subroutine starts and to restore the register in the stack when the subroutine ends. Through such an operation flow, the SPMU 120 may estimate a current stack region by monitoring the code in a master port. The SPMU 120 may estimate a current stack pointer of at least one of the plurality of processors P1 to Pn while storing the stack base and executing the subroutine.

The stack pointer may be updated when a PUSH/POP operation is performed and a stack pointer-related instruction is fetched from the code region.

The SPMU 120 may monitor a bus transaction of the plurality of processors P1 to Pn to check whether a stack pointer region may be updated for each of the plurality of processors P1 to Pn. For example, the SPMU 120 may monitor only the code region access of the plurality of processors P1 to Pn. When the SPMU 120 detects a stack pointer-related instruction, the SPMU 120 may update the corresponding stack region in the CAPT 110.

The SPMU 120 may provide the CAPT 110 with the fact that the property of the stack pointer region is a stack. The start address may be determined at the start, and the size of the stack region in the table may correspond to the size of the region allocated from the stack base to the current stack pointer. The size of the stack region in the table may be updated when at least one of the plurality of processors P1 to Pn updates the stack pointer during the runtime. When the security bus module 100 includes an address or an address range for every transfer, the SPMU 120 may need to perform a relatively small number of logic gates to manage the stack pointer.

The TMBU 130 may monitor a read and write transaction issued by the plurality of processors P1 to Pn and block a transaction issued by an unauthorized processor. The SPMU 120 may update the stack regions of the CAPT 110 for the plurality of processors P1 to Pn. When an invalid processor accesses a particular stack region to overwrite, the TMBU 130 may block the corresponding transaction. The TMBU 130 may check whether the current transaction corresponds to the stack region of the CAPT 110. The TMBU 130 may check whether the processor related to the current transaction is a valid processor. When the current transaction corresponds to the stack region of the CAPT 110 and the processor related to the current transaction is a valid processor, the transaction may be transmitted and the TMBU 130 may forward the transaction to the bus matrix 160. When the current transaction does not correspond to the stack region of the CAPT 110 or the processor related to the current transaction is not a valid processor, the TMBU 130 may block the transaction.

An electronic device, according to an embodiment, may include a processor group 300 including at least one processor and a plurality of processors P1 to Pn including a secure processor P1 operating in a secure world. The electronic device may correspond to the wireless communication device 10, the wireless communication device 10A, and/or the wireless communication device 10B. The electronic device may include a memory 500 storing data related to the plurality of processors P1 to Pn, a CAPT 110 storing access prevention memory region information including a valid master, an access prevention memory region, and properties of the access prevention memory region, a TMBU 130 configured to block, based on the CAPT, a transaction issued by an unauthorized processor with respect to the access prevention memory region among the plurality of processors, an SPMU 120 configured to monitor a stack region of the memory for the plurality of processors, and at least one DMA 400, a channel of which is configured by at least one of the plurality of processors. The access prevention memory region may include a stack region, a protected region, and a secured region. The properties of the access prevention memory region may include stack properties, protected properties, and secured properties. The SPMU 120 may update the stack region of the access prevention memory region information when the stack region of the plurality of processors P1 to Pn changes.

According to an embodiment, the processor group 300 may include a first processor, and when a first access prevention memory region associated with the first processor changes, the first processor may request the secure processor P1 to update first access prevention memory region information. In response to the request, the secure processor P1 may update the first access prevention memory region information associated with the first processor. The secure processor P1 may stop an operation of the processor group 300 before the update and resume an operation of the processor group 300 after the update.

According to an embodiment, the processor group 300 may include a first processor and a second processor, and when the second processor attempts to access a first access prevention memory region of the first processor, the TMBU 130 may determine whether to block the access of the second processor based on first access prevention memory region information about the first processor. When the first access prevention memory region information includes information that the second processor is valid for the first access prevention memory region, the TMBU 130 may allow the access of the second processor. When the first access prevention memory region information does not include information that the second processor is valid for the first access prevention memory region, the TMBU 130 may block the access of the second processor.

According to an embodiment, the processor group 300 may include a first processor and a second processor. The second processor may configure a first channel of the DMA 400, and the security bus module 100 may include a CCU 140 configured to monitor a register value of the first channel of the DMA, and a CCT including DMA configuration information including an ID of the second processor configuring the register value of the first channel of the DMA 400, a source address region of the first channel, and a destination address region of the first channel. When the DMA 400 attempts to access a first access prevention memory region of the first processor through the first channel, the TMBU 130 may determine whether to block the access of the DMA 400 based on first access prevention memory region information about the first processor.

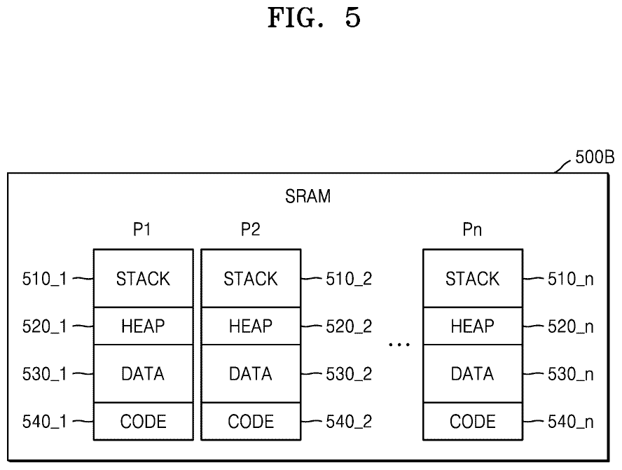

FIG. 5 illustrates a data structure of an SRAM of a wireless communication device including a plurality of processors, according to an embodiment.

Referring to FIG. 5, an SRAM 500B may include and/or may be similar in many respects to the memory 500 and the SRAM 500A described above with reference to FIGS. 1 to 5, and may include additional features not mentioned above. Consequently, repeated descriptions of these components described above with reference to FIGS. 1 to 4 may be omitted for the sake of brevity.

The SRAM 500B may include a plurality of memory regions (e.g., a plurality of stack memory regions (e.g., a first stack memory region 510_1, a second stack memory region 510_2, to an n-th stack memory region 510_n), a plurality of heap memory regions (e.g., a first heap memory region 520_1, a second heap memory region 520_2, to an n-th stack memory region 520_n), a plurality of data memory regions (e.g., a first data memory region 530_1, a second memory region 530_2, to an n-th memory region 530_n), and a plurality of code memory regions (e.g., a first code memory region 540_1, a second memory region 540_2, to an n-th memory region 540_n). The plurality of memory regions of the SRAM 500B may be used by the plurality of processors P1 to Pn. That is, the SRAM 500B may include memory regions that may be used by each of the plurality of processors P1 to Pn. For example, the SRAM 500B may include a plurality of first memory regions (e.g., the first stack memory region 510_1, the first heap memory region 520_1, the first data memory region 530_1, and the first code memory region 540_1) that may be used by the secure processor P1, a plurality of second memory regions (e.g., the second stack memory region 510_2, the second heap memory region 520_2, the second data memory region 530_2, and the second code memory region 540_2) that may be used by the second processor P2, and up to an n-th plurality of memory regions (e.g., the n-th stack memory region 510_n, the n-th heap memory region 520_n, the n-th data memory region 530_n, and the n-th code memory region 540_n) that may be used by the n-th processor Pn. The sizes of the first to n-th stack memory regions 510_1 to 510_n and the first to n-th heap memory regions 520_1 to 520_n may change with time.

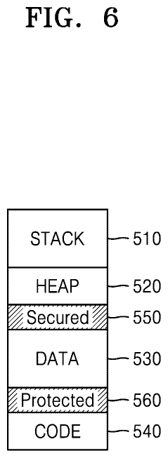

FIG. 6 illustrates memory region allocation, according to an embodiment. FIG. 6 may be described with reference to FIG. 4.

Referring to FIG. 6, a memory 500 used by the plurality of processors P1 to Pn may include a stack region 510, a heap region 520, a data region 530, and a code region 540. According to an embodiment, the code region 540 may include a protected region 560, and the data region 530 may include a secured region 550.

The CAPT 110 may include property information including the stack region 510, the protected region 560, and the secured region 550. Only the processor and/or the DMA 400 having a valid field value (e.g., a high value, “1”, TRUE, or the like) in the CAPT 110 may access the stack region 510, the protected region 560, and/or the secured region 550. However, the present disclosure is not limited in this regard, and the CAPT 110 may use other values to indicate that the processor and/or the DMA 400 may access the stack region 510, the protected region 560, and/or the secured region 550.

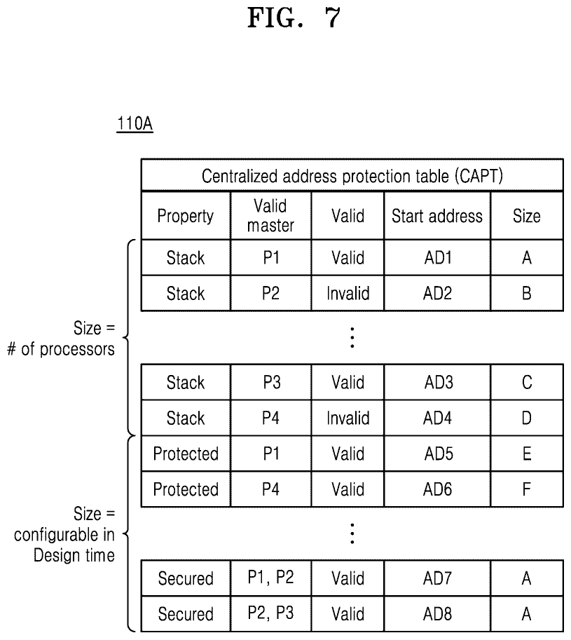

FIG. 7 illustrates an example of a CAPT 110A, according to an embodiment. The CAPT 110A of FIG. 7 may include and/or may be similar in many respects to the CAPT 110 described above with reference to FIG. 4, and may include additional features not mentioned above. Consequently, repeated descriptions of the CAPT 110A described above with reference to FIG. 4 may be omitted for the sake of brevity.

A CAPT 110A may include access prevention memory region (access prevention region) information. For example, the CAPT 110A may include access prevention memory region information about each of a plurality of processors (e.g., the secure processor P1, the second processor P2, a third processor P3, and/or a fourth processor P4).

The access prevention memory region information may include properties of an access prevention memory region, a processor ID, whether a processor corresponding to the processor ID is valid, a start address of the access prevention memory region, and a size of the access prevention memory region. The processor ID may be included in a valid master field. The access prevention memory region information may include a valid master field, and the valid master field may include a processor ID and DMA ID information.

The properties may include a stack region, a protected region, and a secured region.

According to an embodiment, referring to FIG. 7, a stack region allocated to the processor P1 from the SRAM 500A may be valid as an access prevention memory region, a start address of the stack region may be AD1, and a size of the stack region may be A. A protected region allocated to the processor P1 from the SRAM 500A may be valid as an access prevention memory region, a start address of the protected region may be AD5, and a size of the protected region may be E. When each of the plurality of processors P1 to Pn is allocated a stack region from the SRAM 500A, the number of entries having a stack property in the CAPT 110A may be maximized, and may be equal to the number of processors in the plurality of processors P1 to Pn (e.g., the CAPT 110A may have n entries having the stack property). The number of protected regions and secured regions may be configured at design time according to design constraints.

Although the CAPT 110A may be referred to as a table, the present disclosure may not be limited to a table and various data structures including access prevention memory region information may be included as an embodiment. The access prevention memory region information may be used for transaction monitoring and blocking.

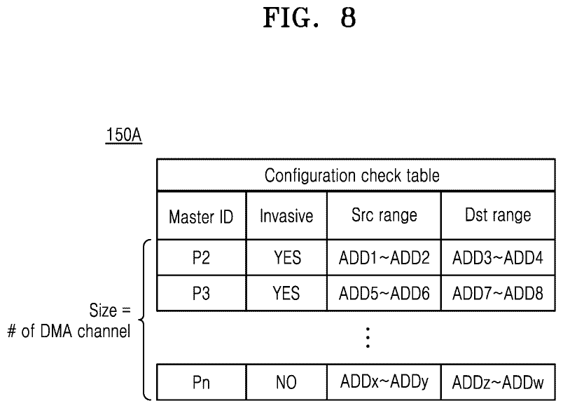

FIG. 8 illustrates a CCT 150A, according to an embodiment. FIG. 8 may be described with reference to FIG. 4. For example, the CCT 150A of FIG. 8 may include and/or may be similar in many respects to the CCT 150 described above with reference to FIG. 4, and may include additional features not mentioned above. Consequently, repeated descriptions of the CCT 150A described above with reference to FIG. 4 may be omitted for the sake of brevity.

Referring to FIG. 8, a CCT 150A may include configuration information. The CCU 140 may be physically implemented using electronic hardware (e.g., analog and/or digital circuits, an integrated circuit, a microprocessor, a microcontroller, a memory circuit, a passive electronic component, an active electronic component, an optical component, or the like), computer software, and/or a combination thereof. The CCU 140 may monitor a bus transaction and may identify which processor has configured a channel of the DMA 400. Referring to FIG. 8, the configuration information may include a master ID, whether invasive or not, a source address region (Src range), and a destination address region (Dst range). A master ID field may include an ID of the processor that has configured a channel of the DMA 400 corresponding to the source address region and the destination address region.

The protected region and the secured region may already be updated in the CAPT 110. The source address region may be a region in which data is already stored. The destination address region may be a new region into which data is to be moved.

The CCU 140 may check whether a configured region damages (e.g., infringes on and/or overlaps) at least one of the protected region and the secured region. The configured region may refer to a region including a source address and a destination address. When an unauthorized DMA is configured to copy data into the protected region and the secured region, an invasive field of the CCT 150A may be set and an alarm may be notified to the secure processor P1.

Because the CCT 150A is monitored by the TMBU 130, the TMBU 130 may detect unauthorized DMA transactions. When an unauthorized transaction is detected by the TMBU 130, the TMBU 130 may block the transaction and transmit an alarm to the secure processor P1. The secure processor P1 may know which processor has configured the DMA 400 with wrong configurations.

Referring to FIG. 8, the channel of the DMA 400 configured by the processor P2 may have a source range of ADD1 to ADD2 (e.g., ADD1˜ADD2) and a destination range of ADD3 to ADD4 (e.g., ADD3˜ADD4). When a memory region having a source range of ADD1 to ADD2 and a destination range of ADD3 to ADD4 has a region overlapping at least one of the protected region and the secured region based on the access prevention memory region information of the CAPT 110, the CCU 140 may determine that the channel of the DMA 400 configured by the processor P2 damages at least one of the protected region and the secured region.

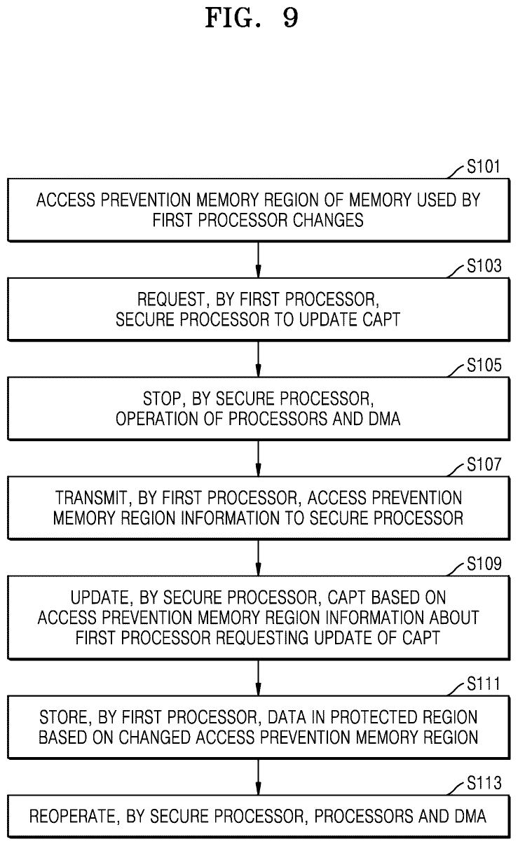

FIG. 9 illustrates an operation of a wireless communication device, according to an embodiment, in the event of a change in an access prevention memory region of a memory used by a processor. FIG. 9 may be described with reference to FIG. 4.

Referring to FIG. 9, in operation S101, an access prevention memory region of a memory used by a first processor may change. The first processor may be any one of the processors 300. According to an embodiment, a new access prevention memory region may be generated by additionally storing data in a region other than access prevention memory region, or the access prevention memory region may be expanded by increasing the stack region. Alternatively or additionally, data may be deleted from the access prevention memory region, or the access prevention memory region may be reduced by decreasing the stack region.

In operation S103, the first processor may request the secure processor P1 to update the CAPT 110. The secure processor P1 may refer to the processor P1 included in the secure world 200. The secure processor P1 may operate only in the secured region and may not perform a user program including an application program. As there is a risk of the first processor modifying the access prevention memory region of another processor, only the secure processor P1 from among the plurality of processors P1 to Pn may directly modify the CAPT 110.

In operation S105, according to an embodiment, the secure processor P1 may stop the operation of the processors and the DMA. The secure processor P1 may stop the access to the memory 500 by all the processors P2 to Pn capable of memory access including the DMA 400 in order to update the CAPT 110.

According to another embodiment, the security bus module 100 may hold all transactions to stop the access to the memory 500 by the processors P2 to Pn. Operation S105 may be performed to prevent the access prevention memory region from being exposed to another processor in the process of updating the CAPT 110. Thus, operation S105 may be omitted when the data update of the access prevention memory region is performed after the CAPT update.

In operation S107, the first processor may transmit access prevention memory region information to the secure processor P1. The access prevention memory region information may include an access prevention memory region, properties of the access prevention memory region needing to be updated, and whether the access prevention memory region is valid. Changes to the access prevention memory region may include, but not be limited to, expansion, reduction, addition, and/or removal of the memory region. The properties may include a stack region, a protected region, and a secured region. The secure processor P1 may mark a validity field of the access prevention memory region as “valid” when the access prevention memory region is newly added and may mark the validity field as “invalid” when the access prevention memory region is deleted.

In operation S109, the secure processor P1 may update the CAPT 110 based on the access prevention memory region information about the first processor requesting the update of the CAPT 110.

In operation S111, the first processor may store data in the protected region based on the changed access prevention memory region. In the case of deleting important data, the first processor may delete the data before the first processor requests the update in operation S103.

When the secure processor P1 has stopped the operation of the processors and the DMA in operation S105, the secure processor P1 may reoperate (e.g., restart) the processors and the DMA in operation S113.

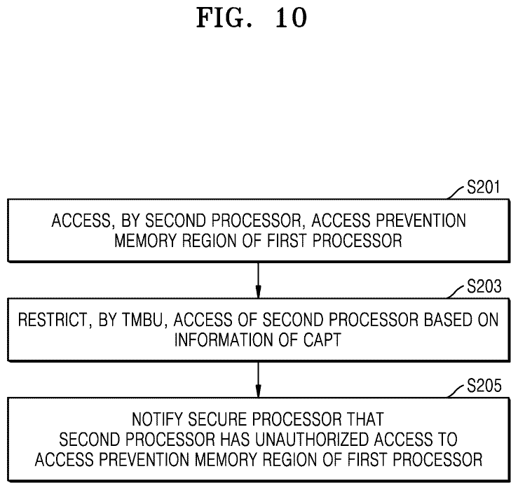

FIG. 10 illustrates an operating method of a wireless communication device including a plurality of processors, according to an embodiment. FIG. 10 may be described with reference to FIG. 4.

The wireless communication device 10 may include a first processor and a second processor. Each of the first processor and the second processor may be one of the processors P2 to Pn.

Referring to FIG. 10, in operation S201, the second processor may access an access prevention memory region of the first processor. The access prevention memory region of the first processor may be already registered in the CAPT 110. When the second processor accesses the access prevention memory region of the first processor, the TMBU 130 may check the CAPT 110.

In operation S203, the TMBU 130 may restrict the access of the second processor based on the information of the CAPT 110. When the access prevention memory region of the first processor accessed by the second processor in the CAPT 110 is a region that is also accessible to the second processor, the TMBU 130 may allow the access of the second processor. When the access prevention memory region of the first processor accessed by the second processor in the CAPT 110 is a region accessible only to the first processor, the TMBU 130 may disallow the access of the second processor.

In operation S205, the TMBU 130 may notify the secure processor P1 that the second processor attempted to access the access prevention memory region of the first processor. When the TMBU 130 disallows the access of the second processor, the TMBU 130 may notify the second processor that the second processor attempted to access the access prevention memory region of the first processor. As there is a possibility that a program executed by the second processor has been contaminated by hacking or the like, the secure processor P1 may initialize the second processor and the program executed by the second processor. For example, the secure processor P1 may re-execute or delete the program executed by the second processor.

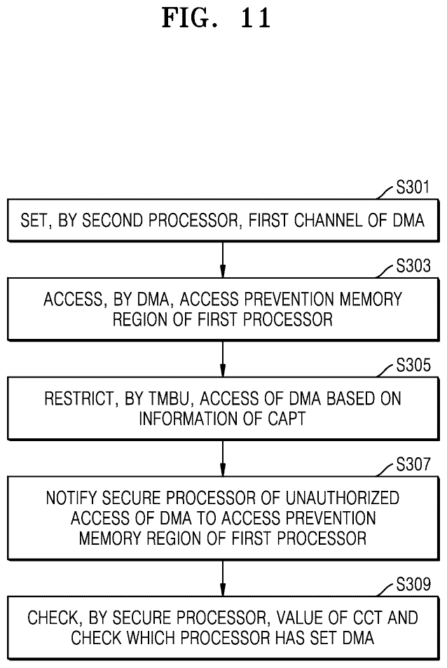

FIG. 11 illustrates an operating method of a wireless communication device including a plurality of processors, according to an embodiment. FIG. 11 may be described with reference to FIG. 4.

The wireless communication device 10 may include a first processor and a second processor. Each of the first processor and the second processor may be one of the processors P2 to Pn.

Referring to FIG. 11, in operation S301, the second processor may set a first channel of the DMA 400. The second processor may configure a first channel of the DMA 400 for a large amount of memory access such as a memory copy. The DMA 400 may have one or more channels. For the memory copy, the second processor may obtain a register value by configuring a source address region and a destination address region in the DMA 400. For example, the second processor may set a special function register (SFR) configuration for the DMA 400 by configuring the source address region and the destination address region. The DMA 400 may perform a memory copy operation based on the register value (e.g., an SFR value). When the memory copy operation starts, the DMA 400 may perform a memory read and/or a write operation by directly accessing the memory of the source address region and the memory of the destination address region without the intervention of the second processor. The number of DMA channels may refer to the number of channels simultaneously performing the memory operation. The DMA register values may be monitored by the CCU 140. The CCU 140 may monitor a transaction of the DMA 400 by monitoring the DMA (400) register values. Through the monitoring of the CCU 140, which processor has set which channel of the DMA 400 may be recorded in the CCT 150.

In operation S303, the DMA 400 may attempt to access the access prevention memory region of the first processor.

In operation S305, the TMBU 130 may restrict the access of the DMA 400 based on the information of the CAPT 110. The TMBU 130 may check the CAPT 110. When the CAPT 110 indicates that the access prevention memory region of the first processor is also accessible to the DMA 400, the TMBU 130 may allow the access of the DMA 400. For example, when the CAPT 110 indicates that the access prevention memory region of the first processor is accessible to the DMA 400, the TMBU 130 may allow the access of the DMA 400. When the CAPT 110 indicates that the access prevention memory region is accessible only to the first processor, the TMBU 130 may disallow the access of the DMA 400.

In operation S307, when the TMBU 130 disallows the access of the DMA 400, the TMBU 130 may notify the secure processor P1 of the unauthorized access of the DMA 400 to the access prevention memory region of the first processor.

In operation S309, the secure processor P1 may check the value of the CCT 150 and check which processor has set the DMA 400. As there is a possibility that a program executed by the second processor has been contaminated by hacking or the like, the secure processor P1 may initialize the second processor and the program executed by the second processor. For example, the secure processor P1 may re-execute and/or delete the program executed by the second processor.

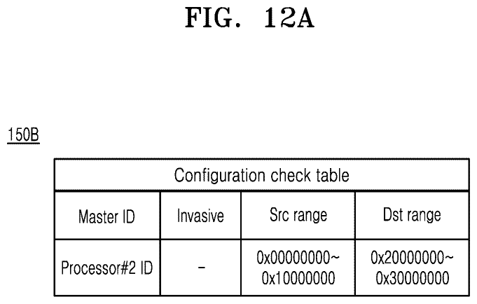

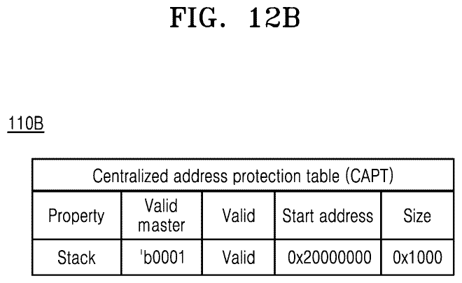

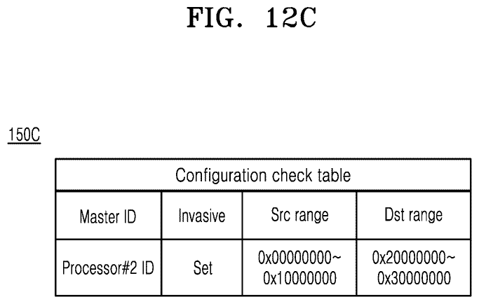

FIGS. 12A, 12B, and 12C illustrate an operating method of a wireless communication device including a plurality of processors, according to an embodiment. FIGS. 12A, 12B, and 12C may be described with reference to FIG. 4. The CCT 150B and the CCT 150C of FIGS. 12A and 12C may include and/or may be similar in many respects to the CCT 150 described above with reference to FIG. 4, and may include additional features not mentioned above. Furthermore, the CAPT 110B of FIG. 12B may include and/or may be similar in many respects to the CAPT 110 described above with reference to FIG. 4, and may include additional features not mentioned above. Consequently, repeated descriptions of the CAPT 110B, the CCT 150B, and the CCT 150C described above with reference to FIG. 4 may be omitted for the sake of brevity.

It may be assumed that the processor #2 (P2) is attacked and, consequently, may configure the DMA 400 to access an access prevention memory region such as a stack memory. That is, the processor #2 (P2) may attempt to configure a DMA SFR with bad (invalid) configurations. The bad configurations may be viewed at a master port of the bus matrix 160 and may be monitored by the CCU 140. When the processor #2 (P2) configures a first channel of the DMA 400, the CCU 140 may update the corresponding content in the CCT 150B as illustrated in FIG. 12A. The invasive field may not yet be updated.

Based on the CAPT 110B of FIG. 12B and the CCT 150B of FIG. 12A, the security bus module 100 may determine that it is invasive when the destination range overlaps the access prevention memory region. Referring to the CAPT 110B of FIG. 12B and the CCT 150B of FIG. 12A, because the destination range overlaps the access prevention memory region, the invasive field may be set as in the CCT 150C of FIG. 12C. Referring to FIG. 12C, the invasive field being “Set” may be equivalent “Yes” and may indicate that the transaction is invasive.

The invasive field information may be transmitted to the processor #1 (P1). The processor #1 (P1) may operate on a root-of-trust. When the DMA 400 accesses the access prevention memory region due to the bad configurations, the TMBU 130 may detect the unauthorized access and notify the processor #1 (P1) of the unauthorized access.

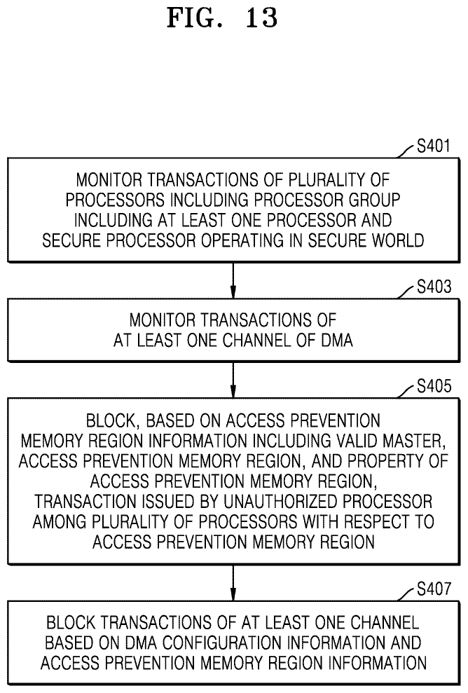

FIG. 13 illustrates an operating method of a wireless communication device including a plurality of processors, according to an embodiment. FIG. 13 may be described with reference to FIG. 4.

Referring to FIG. 13, in operation S401, an electronic device may monitor transactions of a plurality of processors including a processor group 300 including at least one processor and a secure processor P1 operating in a secure world. The electronic device may include the wireless communication device 10.

In operation S403, the electronic device may monitor transactions of at least one channel of the DMA 400.

In operation S405, the electronic device may block, based on access prevention memory region information including a valid master, an access prevention memory region, and properties of the access prevention memory region, a transaction issued by an unauthorized processor with respect to the access prevention memory region among the plurality of processors.

In operation S407, the electronic device may block the transactions of the at least one channel based on the DMA configuration information and the access prevention memory region information.

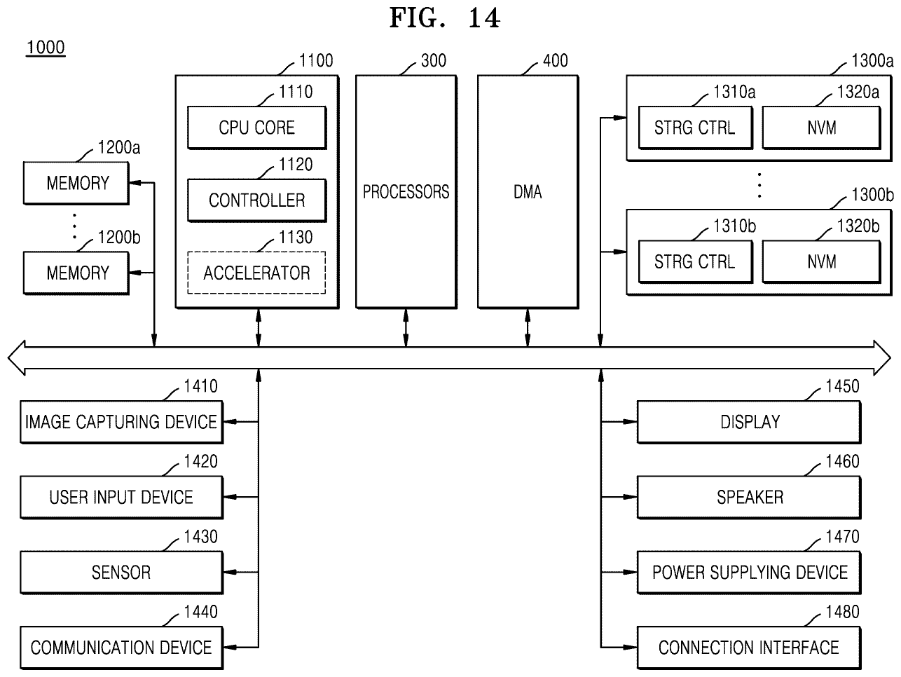

FIG. 14 is a diagram illustrating a system to which a processor group 300 and a DMA 400 are applied, according to an embodiment. FIG. 14 may be described with reference to FIG. 1.

Referring to FIG. 14, a system 1000 may be and/or may include a mobile system such as, but not be limited to, a portable communication terminal (mobile phone), a smart phone, a tablet personal computer (PC), a wearable device, a healthcare device, an IoT device, or the like. However, the system 1000 of FIG. 14 is not necessarily limited to a mobile system and may also be and/or include, for example, a personal computer, a laptop computer, a server, a media player, an automotive device (e.g., a navigation device), or the like.

Referring to FIG. 14, the system 1000 may include a main processor 1100, a plurality of processors 300, a DMA 400, a plurality of memories (e.g., a first memory 1200a and a second memory 1200b), and plurality of storage devices (e.g., a first storage device 1300a and second storage device 1300b), and may further include one or more of an image capturing device 1410, a user input device 1420, a sensor 1430, a communication device 1440, a display 1450, a speaker 1460, a power supply device 1470, and a connection interface 1480. A bus of the system 1000 may correspond to the security bus module 100 described above with reference to FIGS. 1 and 4.

The main processor 1100 may control an overall operation of the system 1000. For example, the main processor 1100 may control an operation of other components constituting the system 1000. The main processor 1100 may be implemented as, for example, a general-purpose processor, a dedicated processor, or an application processor. However, the present disclosure is not limited in this regard.

The main processor 1100 may include one or more CPU cores 1110 and may further include a controller 1120 for controlling the first and second memories 1200a and 1200b and/or the first and second storage devices 1300a and 1300b. According to an embodiment, the main processor 1100 may further include an accelerator 1130 that may be and/or may include a dedicated circuit for high-speed data operation such as, but not limited to, artificial intelligence (AI) data operation. The accelerator 1130 may include, for example, a graphics processing unit (GPU), a neural processing unit (NPU), and/or a data processing unit (DPU), and may be implemented as a separate chip that may be physically independent from other components of the main processor 1100.

The first and second memories 1200a and 1200b may be used as a main memory device of the system 1000 and may include volatile memories such as, but not limited to, SRAMs and/or DRAMs, and/or may include nonvolatile memories such as, but not limited to, flash memories, PRAMs, and/or RRAMs. The first and second memories 1200a and 1200b may also be implemented in the same package as the main processor 1100.

The first and second storage devices 1300a and 1300b may function as a nonvolatile storage device that may store data regardless of whether power is supplied thereto, and may have a larger storage capacity than the first and second memories 1200a and 1200b. The each of the first and second storage devices 1300a and 1300b may include a corresponding storage controller (e.g., a first storage controller 1310a and a second storage controller 1310b) and/or a corresponding non-volatile memory (NVM) (e.g., a first NVM 1320a and a second NVM 1320b) that may store data under the control of the first and second storage controllers 1310a and 1310b, respectively. The first and second NVMs 1320a and 1320b may include a flash memory having a two-dimensional (2D) structure and/or a three-dimensional (3D) vertical NAND (V-NAND) structure, and/or may include other types of NVMs such as, but not limited to, PRAMs and/or RRAMs.

The first and second storage devices 1300a and 1300b may be included in the system 1000 in a state physically separated from the main processor 1100 and/or may be implemented in the same package as the main processor 1100. In an embodiment, the storage devices 1300a and 1300b may have the same shape as a solid state device (SSD) and/or a memory card, and consequently, the first and second storage devices 1300a and 1300b may be coupled to be detachably attached to other components of the system 1000 through an interface such as the connection interface 1480. The first and second storage devices 1300a and 1300b may be and/or may include devices to which a standard protocol such as Universal Flash Storage (UFS), embedded Multi-Media Card (eMMC), or Non-Volatile Memory express (NVMe) may be applied, but are not necessarily limited thereto.

The image capturing device 1410 may capture a still image and/or a moving image and may include, for example, a camera, a camcorder, and/or a webcam.

The user input device 1420 may receive various types of data input from the user of the system 1000 and may include, for example, a touch pad, a keypad, a keyboard, a mouse, and/or a microphone.

The sensor 1430 may detect various types of physical quantities that may be obtained from the outside of the system 1000, and may convert the detected physical quantities into electrical signals. The sensor 1430 may include, for example, a temperature sensor, a pressure sensor, an illuminance sensor, a position sensor, an acceleration sensor, a biosensor, a gyroscope, or the like.

The communication device 1440 may transmit and/or receive signals to and/or from other devices outside the system 1000, according to various communication protocols. The communication device 1440 may be implemented including, for example, an antenna, a transceiver, and/or a modem.

The display 1450 and the speaker 1460 may function as output devices that may respectively output visual information and aural information to the user of the system 1000.

The power supply device 1470 may suitably convert power supplied from a battery built in the system 1000 and/or an external power supply and may supply the power to each of the components of the system 1000.

The connection interface 1480 may provide a connection between the system 1000 and an external device that may be connected to the system 1000 to exchange data with the system 1000. The connection interface 1480 may be implemented in various interface methods such as, but not limited to, Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVM express (NVMe), Institute of Electrical and Electronics Engineers (IEEE) 1394 (FireWire™, i.LINK™, Lynx™), Universal Serial Bus (USB), Secure Digital (SD) card, Multi-Media Card (MMC), eMMC, UFS, embedded Universal Flash Storage (eUFS), and/or Compact Flash (CF) card interface.

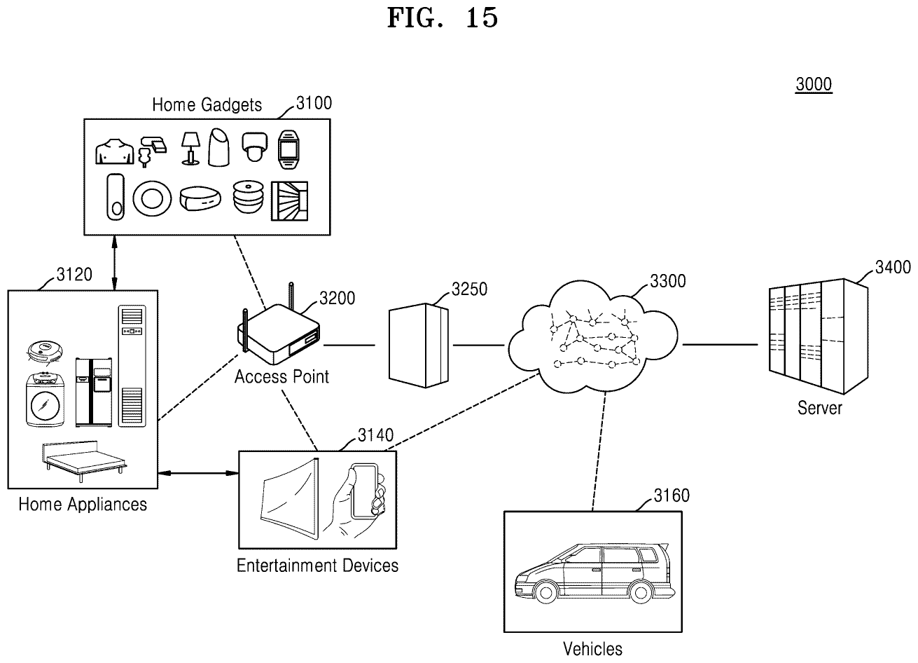

FIG. 15 is a conceptual diagram illustrating an IoT network system to which one or more embodiments are applied.

Referring to FIG. 15, an IoT network system 3000 may include a plurality of IoT devices (e.g., home gadgets 3100, home appliances 3120, entertainment devices 3140, and vehicles 3160), an access point 3200, a gateway 3250, a wireless network 3300, and a server 3400. IoT may refer to a network between things (e.g., devices) using wired and/or wireless communications.

Each of the IoT devices 3100 to 3160 may form a group according to the characteristics of each IoT device. For example, the IoT devices 3100 to 3160 may be grouped into a home gadget group 3100, a home appliance/furniture group 3120, an entertainment group 3140, a vehicle group 3160, or the like. A plurality of IoT devices (e.g., home gadgets 3100, home appliances 3120, and entertainment devices 3140) may be connected to a communication network or to another IoT device through the access point 3200. The access point 3200 may be built in one IoT device. The gateway 3250 may change the protocol to connect the access point 3200 to an external wireless network. The IoT devices 3100 to 3140 may be connected to an external communication network through the gateway 3250. The wireless network 3300 may include the Internet and/or a public network. The plurality of IoT devices 3100 to 3160 may be connected through the wireless network 3300 to the server 3400 providing a certain service, and the user may use a service through at least one of the plurality of IoT devices 3100 to 3160.

According to embodiments, each of the plurality of IoT devices 3100 to 3160 may include a plurality of processors P1 to Pn and the security bus module 100 described above with reference to FIGS. 1 and 4. Accordingly, a stack region of each of the plurality of processors P1 to Pn of the plurality of IoT devices 3100 to 3160 may be protected. That is, the plurality of processors P1 to Pn may be prevented from invading (or damaging) the stack regions of each other's processors. In addition, a memory region of each of the plurality of processors P1 to Pn of the plurality of IoT devices 3100 to 3160 may be protected from non-secure access.

In the above embodiments, components have been described by using terms such as first, second, and third. However, the terms such as first, second, and third are used to distinguish the components from each other and do not limit the inventive concept. For example, the terms such as first, second, and third do not imply orders or numerical meanings of any forms. In the above embodiments, components have been referenced by using blocks. The blocks may be implemented as various hardware devices such as an integrated circuit (IC), an application-specific IC (ASIC), a field programmable gate array (FPGA), and a complex programmable logic device (CPLD), as firmware driven in hardware devices, as software such as applications, or as a combination of hardware devices and software. Also, the blocks may include circuits including semiconductor devices in an IC or circuits registered as intellectual property (IP).

While the present disclosure has been particularly shown and described with reference to embodiments thereof, it is to be understood that various changes in form and details may be made therein without departing from the spirit and scope of the following claims.

What is claimed is:

1. An electronic device comprising:
a plurality of processors comprising a secure processor operating in a secure execution environment and a processor group comprising at least one processor;
one or more processors comprising processing circuitry; and
a memory storing instructions and data related to the plurality of processors,
wherein the instructions, when executed by the one or more processors individually or collectively, cause the electronic device to:
block a transaction, issued by an unauthorized processor from among the plurality of processors, with respect to an access prevention memory region, based on access prevention memory region information comprising a valid master, identification information of the access prevention memory region, and properties of the access prevention memory region.

2. The electronic device of claim 1, wherein the access prevention memory region comprises at least one of a stack region, a protected region, or a secured region, and
wherein the properties of the access prevention memory region comprise at least one of stack properties, protected properties, or secured properties.

3. The electronic device of claim 2, wherein the instructions, when executed by the one or more processors individually or collectively, further cause the electronic device to:
monitor the stack region of the memory for the plurality of processors; and
update the stack region of the access prevention memory region information based on changes to the stack region.

4. The electronic device of claim 1, wherein the processor group comprises a first processor,
wherein the first processor is configured to, request, based on a first access prevention memory region being associated with the first processor changes, the secure processor to update first access prevention memory region information, and
wherein the secure processor is configured to update the first access prevention memory region information associated with the first processor, based on the request.

5. The electronic device of claim 4, wherein the secure processor is configured to:
stop an operation of the processor group before the update to the first access prevention memory region information; and
resume the operation of the processor group after the update to the first access prevention memory region information.

6. The electronic device of claim 1, wherein the processor group comprises a first processor and a second processor, and
wherein the instructions, when executed by the one or more processors individually or collectively, further cause the electronic device to determine, based on the second processor attempting to access a first access prevention memory region of the first processor, whether to block the access of the second processor based on first access prevention memory region information about the first processor.

7. The electronic device of claim 6, wherein the instructions, when executed by the one or more processors individually or collectively, further cause the electronic device to:
allow the access of the second processor based on the first access prevention memory region information comprising information indicating that the second processor is valid for the first access prevention memory region; and
block the access of the second processor based on the first access prevention memory region information not comprising the information indicating that the second processor is valid for the first access prevention memory region.

8. The electronic device of claim 1, further comprising:
at least one direct memory access (DMA) comprising a channel configured by at least one of the plurality of processors.

9. The electronic device of claim 8, wherein the processor group comprises a first processor and a second processor,
wherein the second processor is configured to configure a first channel of the DMA, and
wherein the instructions, when executed by the one or more processors individually or collectively, further cause the electronic device to:
store DMA configuration information including an identification (ID) of the second processor, a source address region of the first channel, and a destination address region of the first channel by monitoring a register value of the first channel of the DMA; and
determine, based on the DMA attempting to access a first access prevention memory region of the first processor through the first channel, whether to block the access of the DMA based on first access prevention memory region information about the first processor and the DMA configuration information.

10. The electronic device of claim 9, wherein the instructions, when executed by the one or more processors individually or collectively, further cause the electronic device to:
allow the access of the DMA based on the first access prevention memory region information comprising information indicating that the DMA is valid for the first access prevention memory region; and
block the access of the DMA based on the first access prevention memory region information not comprising include the information indicating that the DMA is valid for the first access prevention memory region.

11. An electronic device comprising:
a plurality of processors comprising a secure processor operating in a secure execution environment and a processor group comprising at least one processor;
one or more processors comprising processing circuitry;
a memory storing instructions and data related to the plurality of processors;
a centralized address protection table (CAPT) storing access prevention memory region information comprising a valid master, an access prevention memory region, and properties of the access prevention memory region; and
at least one direct memory access (DMA) comprising a channel configured by at least one of the plurality of processors,
wherein the instructions, when executed by the one or more processors individually or collectively, cause the electronic device to:
block, based on the CAPT, a transaction, issued by an unauthorized processor from among the plurality of processors, with respect to the access prevention memory region; and
monitor a stack region of the memory for the plurality of processors.

12. The electronic device of claim 11, wherein the access prevention memory region comprises at least one of the stack region, a protected region, or a secured region, and
wherein the properties of the access prevention memory region comprise at least one of stack properties, protected properties, and secured properties.

13. The electronic device of claim 12, wherein the instructions, when executed by the one or more processors individually or collectively, further cause the electronic device to:
update the stack region of the access prevention memory region information based on changes to the stack region of the plurality of processors.

14. The electronic device of claim 11, wherein the processor group comprises a first processor,
wherein the first processor is configured to, request, based on a first access prevention memory region associated with the first processor changes, the secure processor to update first access prevention memory region information, and
wherein the secure processor is configured to update the first access prevention memory region information associated with the first processor based on the request.

15. The electronic device of claim 14, wherein the secure processor is configured to:
stop an operation of the processor group before the update to the first access prevention memory region information; and
resume the operation of the processor group after the update to the first access prevention memory region information.

16. The electronic device of claim 11, wherein the processor group comprises a first processor and a second processor, and
wherein the instructions, when executed by the one or more processors individually or collectively, further cause the electronic device to determine, based on the second processor attempting to access a first access prevention memory region of the first processor, whether to block the access of the second processor based on first access prevention memory region information of the CAPT about the first processor.

17. The electronic device of claim 16, wherein the instructions, when executed by the one or more processors individually or collectively, further cause the electronic device to:
allow the access of the second processor based on the first access prevention memory region information comprising information indicating that the second processor is valid for the first access prevention memory region; and
block the access of the second processor based on the first access prevention memory region information not comprising the information indicating that the second processor is valid for the first access prevention memory region.

18. The electronic device of claim 11, wherein the processor group comprises a first processor and a second processor,
wherein the second processor is configured to configure a first channel of the DMA,
wherein the instructions, when executed by the one or more processors individually or collectively, further cause the electronic device to monitor a register value of the first channel of the DMA,
wherein the electronic device further comprises a configuration check table (CCT) comprising DMA configuration information comprising an identification (ID) of the second processor configuring the register value of the first channel of the DMA, a source address region of the first channel, and a destination address region of the first channel, and
wherein the instructions, when executed by the one or more processors individually or collectively, further cause the electronic device to determine, based on the DMA attempting to access a first access prevention memory region of the first processor through the first channel, whether to block the access of the DMA based on first access prevention memory region information of the CAPT about the first processor.

19. The electronic device of claim 18, wherein the instructions, when executed by the one or more processors individually or collectively, further cause the electronic device to:
allow the access of the DMA based on the first access prevention memory region information comprising information indicating that the DMA is valid for the first access prevention memory region; and
block the access of the DMA based on the first access prevention memory region information not comprising the information indicating that the DMA is valid for the first access prevention memory region.

20. An operating method of an electronic device, the operating method comprising:
monitoring transactions of a plurality of processors comprising a secure processor operating in a secure execution environment and a processor group comprising at least one processor;
monitoring transactions of at least one channel of a direct memory access (DMA);
blocking, based on access prevention memory region information, a transaction, issued by an unauthorized processor from among the plurality of processors, with respect to an access prevention memory region, the access prevention memory region information comprising a valid master, identification information of the access prevention memory region, and properties of the access prevention memory region; and
blocking the transactions of the at least one channel based on DMA configuration information and the access prevention memory region information,
wherein the DMA configuration information comprises an identification (ID) of a processor configuring the DMA, a source address region of the at least one channel, and a destination address region of the at least one channel.
